(19) United States
(12) Patent Application Publication
(10) Pub. No.: US 2003/0156912 A1
(43) Pub. Date: Aug. 21, 2003

(54) Metal cutting tools

(76) Inventor: Harry Ono, Des Plaines, IL (US)

Correspondence Address: James A. Geppert, 120 Washington Street, Glenview, IL, 60025, US

(21) Appl. No.: 10/339,505

(22) Filed: Jan. 9, 2003

Related U.S. Application Data
(60) Provisional application No. 60/350,776, filed on Jan. 22, 2002.

(51) Int. Cl. B23B 51/02

(52) U.S. Cl. 408/229

(57) ABSTRACT

Metal cutting tools, such as drills or reamers, utilized to produce holes with substantially improved finishes and sizes at faster speed and feed rates having a double cutting action, said tool comprising a reamer having a plurality of cutting flutes with a 45° primary cutting surface and a tapered secondary cutting surface, the primary surface including slots or grooves thereon, and each flute may have a margin on the O.D. of the flute or a relief angle to provide accurate cutting operations.

### FIELD OF INVENTION

The present application is a continuation of a provisional patent application entitled “Metal Cutting Reamers With Double Cutting Action” filed Jan. 22, 2002 and assigned provisional Ser. No. 60/350,776, which is incorporated by reference.

### BACKGROUND OF THE INVENTION

This invention is for metal cutting tools, and more specifically for reamers, which produce (cuts) holes to substantially better finishes and sizes, at a faster speed (RPM) and feed rate, than those that are presently available. This invention will be named D-C reamers, for the double cutting action of these designs. Reamers are typically used as a secondary operation within a drilled or bored hole that may vary in sizes from 1/32 inch to over 6 inches in diameter.

The quality of a reamed hole is determined by the roundness, the accuracy of the inside diameter, which is the plug size, and the surface roughness. For this disclosure, the roughness will be defined as the peak-to-peak dimension of the surface.

Reamers that are readily available from mill supply stores consist of a number of flutes (longitudinal blades) with 45° cutting points. A ½ inch reamer typically contains six flutes.

Many types of custom-made reamers are presently available. However, all of these designs have deficiencies, which prevent their use for general, commercial applications. The Machinery's Handbook, Seventeenth Edition, page 1414 states, “Hand reamers are tapered slightly on the end to facilitate proper starting.” Also, page 1414 a illustrates a starting taper, with sharp edges (no margins). This illustration is labeled “Hand Reamer Point”. No dimensions are specified and the function of the taper is to facilitate the starting entry of the reamer into a hole, presumably for enlarging the hole diameter. It is commonly known that reamers and metal cutting tools are functionally sensitive to the cutting speeds (RPM) and designs that function well at extremely slow speeds may be unacceptable at any reasonable production machine speeds. Some details of the present invention may be considered to be broadly similar to present teachings, however, the precise details and dimensions that were developed as presented in this invention provide different functions and results.

Several problems involved with the development of this invention were:

Item one: Accuracies and measurement of one or two ten-thousandths of an inch are not easy to produce or measure.

Item two: The dynamics occur within a hole, which is difficult or impossible to observe.

Item three: Various metals produce different results.

Item four: The reamer is a simple design; however, small variations on each detail were found to be inter-related on many combinations and designs and testing of all the combinations and permutations would have required many years of effort. Therefore, a small amount of analytic assumptions were substituted for sample tests.

Item five: Some of the tests required grinding of some surfaces to variations of twenty five millionths of an inch which is greater that the normal accuracy of standard shop equipment. For example, a small roughness or waviness on normally straight shave edges on some design combinations provided the same results as grooves or slots.

Reamers of about 0.500 inch diameter are generally expected to finish holes to a plug gauge size not more that 0.0005 inch over the reamer size, with a roughness not to exceed 0.001 inch. On many items, this size and finish is not accurate enough, therefore, the reaming operation is followed with a shaving, honing or grinding process. High precision reamers used with a double reaming operation (i.e. to ream within 0.002 inch undersize followed by an “on size” reamer) may reduce both tolerances by 50%.

### SUMMARY OF THE INVENTION

This invention provides a design(s) that is simple and low cost to manufacture with standard production equipment, with means to easily re-sharpen dull reamers, and substantially improve the performance with non-critical set-ups and operational variations.

Three new basic concepts along with small additional details are presented in this invention:

Concept one: Small slots or grooves on the outside diameter cutting surfaces are provided for some combinations of details on the reamer design.

Concept two: A precisely determined, tapered, shaving surface on the O.D. of the reamer is provided to eliminate galling and chatter of the reamer

Concept three: The tapered shaving edges are designed to shave away the rough initial cut of the leading 45° edges.

It has been observed that a reamer finishes a hole oversize and rough due to four factors. First is thermal expansion. Second is tearing of the metal. Third is the increased diameter of the reamer due to galling (adhesion of the metal on the outside diameter and face of the tool), the second and third factors being inter-related. Fourth is reamer chatter, which is a commonly used terminology.

With respect to the first factor, most steels expand at the rate of about 7μ in/° F./in. Therefore, if the reamer (when in use) heats up by 25° F., then the reamer (having a ½ inch diameter) expands (25)×(7μ in.)×(½ in.)≅90μ-in≅0.0001 in. Reducing the cutting friction and galling reduces the heat generated.

As to the second factor, when the reamer cuts the metal, the metal is torn (peeled) off the surface; somewhat like peeling an orange. Depending on many variables, the roughness created by the tearing may be large or small and non-uniform. These variables can include the type of metal (aluminum, brass), type of steel (leaded, grain size), coefficient of friction, degree of strain hardening, angle of the cutter surface, sharpness of the cutting edge, depth of cut, lubrication, cutting speed as well as other variables. Therefore, the 0.0005 in. over the reamer size mentioned above is very roughly approximate and can vary, for example, from about 0.0002 to about 0.002 inch.

With regard to factor three, when metals are rubbed together at very high pressures, there is a tendency for the softer metal to stick onto the surface of the harder material in spots or in small areas. This is known as “galling.” Galling is a function of many variables, such as coefficient of friction between the two materials, grain size, shear strength, pressure, velocity, lubricity of the metals, as well as other variables.

The fourth factor is a tendency of reamers to chatter and create a multi-sided hole which is always one unit more than the number of flutes for uniformly spaced flutes. This problem is the most difficult to eliminate when the reamer is designed to cut a precision hole.

On all cutting tools, some galling is always present. This may be microscopically small or significantly large. On reamers, galling is always a factor which increases the inaccuracy of the hole size. When galling builds up on the O.D. of the reamer, this effectively increases the inaccuracy of the hole size. When galling builds up on the O.D. of the reamer, this effectively increases the reamer diameter. However, the thickness of the galling builds up and wears off as the reamer rotates. The constantly changing thickness and width of the galling contributes to the surface roughness of the hole.

### BRIEF DESCRIPTION OF THE DRAWINGS

FIG. 1 is a cross section of a work-piece with a reamed hole and plug gage to illustrate the surface roughness of the reamed hole.

FIG. 2 is a side elevational view of a (shortened) standard reamer.

FIG. 3 is a cross sectional view of the reamer taken on the line A-A of FIG. 2.

FIG. 4 is a partial side view of one flute as viewed from the direction of arrow 3 of FIG. 2 illustrating how gall adheres to the cutting edge.

FIG. 5 is a right side view of FIG. 4.

FIG. 6 is the same view as FIG. 4 illustrating that sometimes gall adheres to the apex of the flute diameter.

FIG. 7 is a right side view of the flute of FIG. 6.

FIG. 8 is a view similar to FIG. 6, but illustrating a shave angle with a partially slotted edge.

FIG. 9 is a view similar to FIG. 8, but showing grooves on the shave edge.

### ILLUSTRATIVE EMBODIMENTS OF THE INVENTION

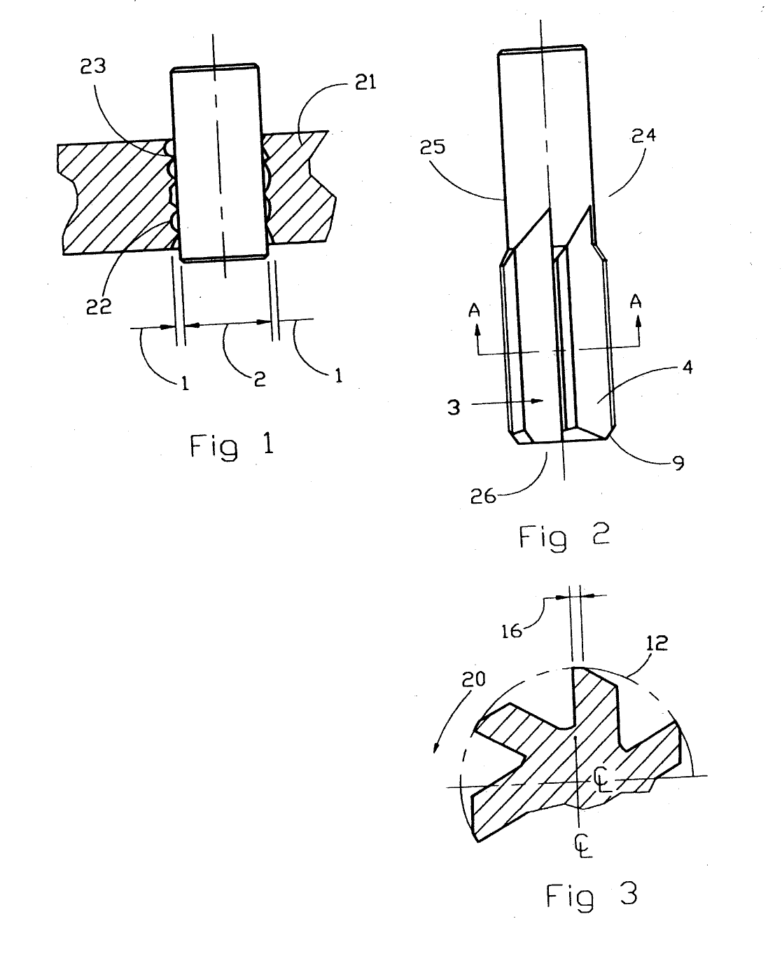

Referring more particularly to the disclosure in the drawings where are shown illustrative embodiments of the present invention, FIG. 1 illustrates a work-piece 21 having a hole 22 reamed therethrough and showing irregularities or surface roughness 23 in the surface of the reamed opening caused by a reamer. One parameter of the quality of a reamed hole is determined by the roundness and the accuracy of the inside diameter, which is the plug size 2. For this invention the roughness of the inside surface will be defined as the peak-to-peak dimension 1 of the surface.

FIG. 2 illustrates a conventional reamer 24 having a shank 25 with an end 26 provided with a number of flutes (longitudinal blades) 4 and provided with 45° cutting edges or points 9. A ½ inch reamer, for example, contains six flutes 4. As seen in FIG. 3, the O.D. 12 of the reamer is formed by the cutting edges 9 with the shave angle having a margin width 16; the reamer rotating in the direction of the arrow 20.

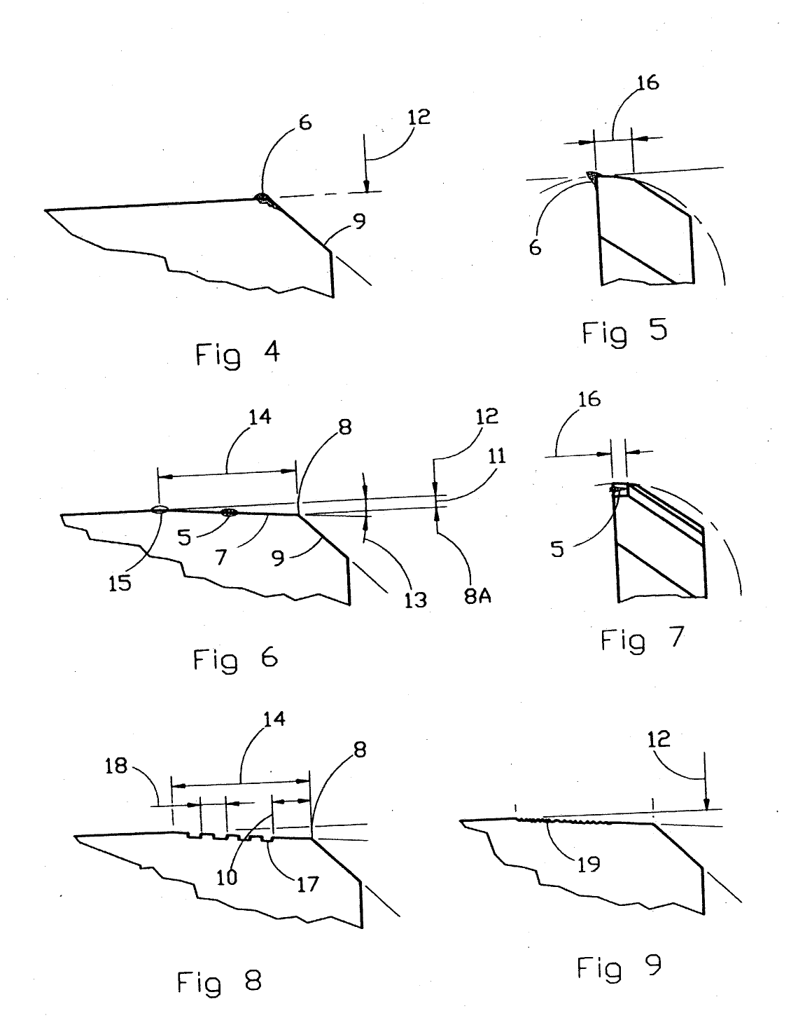

Considering FIGS. 4 and 5, the cutting edge 9 of the reamer has galling 6 shown as building up on the O.D. 12 of the reamer flute. Galling is always present on all cutting tools and may either be microscopically small or significantly large. On reamers, galling is always a factor which increases the inaccuracy of the hole size, which effectively increases the reamer diameter. Major efforts were done to eliminate or minimize the galling. Several methods that produced marginally beneficial results were:

1. Grinding a radius at the apex of the 45° point surfaces to the O.D. of the reamer.

2. A two and three step diameter cutting point, whereby each step was ground with the O.D. diameter being 0.0015 inches smaller than the following step, with the last step being 0.0015 inch smaller than the O.D.

3. A tapered shaving edge 7 (see FIG. 6) with a cutting point 8, whereby the 45° edge 9 terminated at a diameter 8A (FIG. 6) 0.004 inch less (see numeral 11) than the reamer O.D. 12, followed by an angle 13 of 4°, which created a shave angle with a taper length 14 of L=0.002 ctan 4°=0.028 inch. This caused the gall 6 to shift from the 45° apex over to the other end 15 of the 4° taper. The roughness decreased slightly, on the average, from about 0.0012 inch to about 0.001 inch with the taper.

Continued tests at 6°, 3°, 2°, 1.50°, and 1° progressively reduced the roughness at the smaller shave angles. At 1°, the roughness decreased to an average of about 0.0005 inch. However, at the smaller shave angles, the 0.028 inch length 14 had to be increased. A noticeable tool chatter developed starting at about 0.040 inch length. This chatter developed a seven-sided hole, which in the most severe sample created an I.D. of 0.4996 (as measured with a plug gage) with a roughness plus waviness dimension of about 0.0012 inch.

Galling is the process whereby metal adheres to the reamer surface, and roughness is the surface finish after a part is reamed. Galling contributes to and becomes a factor in creating the surface roughness. A margin on reamers is an axial surface on the reamer O.D. with a small radial width of a constant diameter 16. To decrease galling, the margin width 16 of the shave angle was progressively increased from a sharp edge to 0.010 inches wide. The width of this margin on the flute O.D. is normally about 0.012 inch. Starting at 0.005 inches wide, galling 5 occurred on the margin with increasing frequency and size. At a margin width of 0.015 inch, the galling was functionally unacceptable. Reducing the surface cutting speed from forty feet/minute to twenty feet/minute eliminated this problem at a 0.010 inch margin. Also, increasing the feed rate decreased the galling problem slightly.

A few no gall, no waviness (no chatter) tests indicated that the roughness decreased significantly at angles less than 2° and increased significantly at angles greater than 3°. At angles greater than 6°, the roughness was about the same as no shave angel and body diameter 12. Interestingly, it seems that at any small shave angle 13, the gall 6 that normally accumulates at the 45° apex 9, shifts up along the shave edge until it encounters a disruption, such as a groove, apex or step, and accumulates into a projection 15 at the disruption. The gall at the 45° apex is never completely eliminated, but the projection outward, which increases the O.D., is extremely small, estimated at zero at 3° and about 0.0002 inch at 1°. The gall at the apex of the shave angle (to reamer diameter) projects radially outward from about 0.001 inch at 6° shave angle to about 0.0005 inch at 3° and 0.0001 at about 1° or less.

Summarizing, the gall at the 45° apex slowly increases at shave angles of less than 3° and the gall at the end of the shave angle rapidly decreases at shave angles less than 3°. This phenomenon provides an easy compromise of shave angles of ¼° to 2°, preferably less than 10. The evaluation at the end of these tests was that a small shave angle of ¼° to 2° without tool chatter would be ideal.

With respect to FIGS. 8 and 9, a series of tests were done with grooves 19 (FIG. 9) in place of the straight shave angle 7. The roughness varied widely between 0.00005 and 0.0012 inch. It seemed to vary depending on the groove spacing and feed rate. Most tests were made at a feed rate of about 0.004 inch per tooth per revolution. Grooving the shave angle eliminated the tool chatter problem, but created two others. Problem one was that small slivers of metal sometimes became hooked in the groove and effectively functioned the same as a gall, which increased the diameter and roughness. Problem two was that the spiral angle and the relief angle of the grooves seemed to be too critical. Reducing the groove depth to less than 0.0002 inch eliminated these two problems.

Next, a series of tests were done with slots 17 (see FIG. 8). The results were much more consistent and best when the slot spacing 18 was less than 0.005 inch apart with a slot width of about 0.002 inch wide and a depth of about 0.0002 inch. The roughness was consistently less than 0.0007 inch with many samples as small as 0.0001 inch. These results seemed to be almost the same at all angles between 0° and 2°. Chatter was eliminated with shave angle lengths 14 of up to 3/16 inch.

However two problems arose with the slotting. The first problem was that, infrequently, metal galls at the 45° apex 9, which is speculated to be due to the position of the first slot. For example, depending on where the first slot 17 is positioned, the 45° apex 9 could terminate at a diameter of the shave surface apex or at 0.0002 inch (slot depth) less. The jagged leading edge created by the slot problem. The second problem is that with slots on the shave angle, galling occurred on the slot(s) margin at certain speeds, feeds and shave angles. The problem was eliminated by limiting the speed rate to forty feet per minute and the feed rate to 0.005 inch/tooth/revolution and the shave angle to less to 1°.

To summarize the present invention, the shave angle on the reamers eliminated (or substantially reduced) the galling at the 45° apex and shaves away surface roughness. The slots or grooves on the shave angle stabilizes the rotation of the reamers, reduces the margin area in contact with the wall of the hole, which in turn reduces the rotational heat generated and reduces (or eliminates) galling of the shave angle margin. The slots or fine grooves also allow lubrication to be transported around with the reamer in rotation, which coats the wall of the hole and improves the reamer performance. The good stability and cutting dynamics of these reamers allow a back taper on the outside diameter of the reamer flutes.

The final best results were obtained with the following designs.

1. Shave angle of 0.2° to 1.5°.

2. Shave angel length less than 0.100 inch.

3. Margin width between 0.005 and 0.015 inch.

4a. Slots less than 0.0004 inch deep, spaced less than 0.010 inch apart.

4b. Grooves less than 0.0002 inch deep, spaced at random.

4c. A straight shave angle edge if the length does not exceed 0.0060 inch and the margin width is 0.005 to 0.010 inch.

5. It is preferred to position the slots or grooves starting at about 0.030 inch away from the 45° angle 10.

Most tests were done with ½ inch diameter reamers. Shave angle details and dimensions must be adjusted slightly for larger or smaller diameters and also may be adjusted for the type of cutting lubricant, method of applying the lubricant/coolant, rigidity of the production set-up, material of the reamer and material of the work-piece.

Some of the better performance 0.0005 inch diameter DC reamer design(s) consistently produced holes of 0.5001±0.0001 inch diameter and a roughness of about 0.00025±0.0001 inch, as compared to standard reamers which produce holes of 0.5004±0.0003 inch diameter with a roughness of about 0.0008±0.0004 inch. The feed rate of about 0.012 to 0.030 inch per revolution is more than two times faster than standard reamers.

Starting the slots 17 at about 0.030 inch, indicated as 10, behind the 45° edge 8 allow material for resharpening about five times. A typical drilled hole size for a 0.500 inch reamer is 0.484 inch diameter, therefore, the 45° cutting edge dulls fastest and resharpening requires removal of about 0.005 inch off of the 45° edge. Reamers are used for a wide variety of requirements and materials with many different types of fabrication equipment, therefore, a specific design requires a consideration of all the parameters.

Some factors which are required: Cost of the reamer and material of the reamer (highspeed steel, carbide or diamond), workpiece material, type of machine, process objective (finish, fast processing, precision size, reliability, tool life, set-up time and cost), lubrication used and type of application (drip or high pressure), blind hole or through hole, bottom clearance, type of machine available for the manufacture of the reamers, environmental temperature, etc.

Four examples are provided:

I. For a low cost, general purpose, high speed steel, chucking (straight shank), ½ inch diameter reamer:

1. Shave angle: 0.80, length 0.070 inch.

2. Margin width: 0.012 inch.

3. Slots: 0.003 inch wide, 0.0002 inch deep, 0.0005 inch spacing.

4. Position slots 0.030 inch from the 45° point.

II. An alternate design is:

1. Shave angle: 0.6°, length 0.060 inch.

2. Margin width: 0.008 inch

3. Grooves: 0.00015±0.00001 inch deep, spaced at random.

III. For a high precision, smooth finish, through hole, carbide reamer used on a CNC (automatic) mill, for bearing steel (52100):

1. Shave angle: 0.3°, length 0.05 inch.

2. Margin width: 0.005 inch

3. No grooves, straight shave edges.

IV. For cast iron, blind hole, carbide, CNC mill:

1. Shave angle: 0.2°, length 0.03 inch.

2. Margin: 0.015 inch.

3. Straight shave edges.

The teachings of this disclosure are directed towards metal cutting reamers; however, the principles and details presented may be applied to various other types of relates cutters, such as spot facing cutters, end cutters, drills, combination drill/reamers, adjustable reamers and the like.

1. A metal cutting reamer comprising: a plurality of flutes with primary cutting edges ground at a 45° angle, and secondary longitudinally extending tapered shaving edges provided with margins.

2. A metal cutting reamer as set forth in claim 1, wherein said margins are in the range of 0.002 to 0.020 inch wide.

3. A metal cutting reamer as set forth in claim 1, wherein said margins are in the range of 0.004 to 0.015 inch wide.

4. A metal cutting reamer as set forth in claim 1, wherein said tapered edges are less than 0.20 inch long.

5. A metal cutting reamer as set forth in claim 1, wherein said tapered edges are less than 0.15 inch long.

6. A metal cutting reamer as set forth in claim 1, wherein said tapered edges are less than 0.10 inch long.

7. A metal cutting reamer as set forth in claim 2, wherein said tapered edges are less than 0.20 inch wide.

8. A metal cutting reamer as set forth in claim 1, wherein said shaving edges are provided with slots or grooves less than 0.002 inch deep and spaced apart less than 0.020 inch and greater than 0.0001 inch wide.

9. A metal cutting reamer as set forth in claim 8, wherein said slots or grooves are positioned to provide, adjacent to the primary cutting edges, a short length of straight shave edges of not less than 0.010 inches.

10. A metal cutting reamer as set forth in claim 1, wherein said tapered edges are angled less than 4° with respect to the centerline of the reamer.

11. A metal cutting reamer as set forth in claim 1, wherein said tapered edges are angles less than 2° with respect to the centerline.

12. A metal cutting reamer as set forth in claim 1, wherein said tapered edges are angled less than 1° with respect to the centerline.

13. A metal cutting reamer as set forth in claim 2, wherein said tapered edges are less than 0.20 inch long and are angled less than 4° with respect to the centerline.

14. A metal cutting reamer as set forth in claim 8, wherein said tapered edges are angled less than 4° with respect to the centerline.

15. A metal cutting reamer as set forth in claim 9, wherein said tapered edges are angled less than 4° with respect to the centerline.

16. A metal cutting reamer comprising: a plurality of flutes on the cutting end with primary cutting edges ground to a 45° angle and secondary longitudinally extending shaving edges, each edge being provided with a relief angle providing a sharp edge.

17. A metal cutting reamer as set forth in claim 16, wherein said tapered edges are less than 0.20 inch long.

18. A metal cutting reamer as set forth in claim 16, wherein said shaving edges are provided with slots or grooves less than 0.002 inch deep and spaced apart less than 0.020 inch and greater than 0.0001 inch wide.
